(19) United States
(12) Patent Application Publication
(10) Pub. No.: US 2026/0100490 A1
(43) Pub. Date: Apr. 9, 2026

(54) COVER MEMBER

(71) Applicants: SUMITOMO WIRING SYSTEMS, LTD., Mie-ken (JP); TOYOTA JIDOSHA KABUSHIKI KAISHA, Aichi-ken (JP)

(72) Inventors: Shota WATANABE, Yokkaichi-shi (JP); Masatoshi HAYASHI, Toyota-shi (JP)

(73) Assignees: SUMITOMO WIRING SYSTEMS, LTD., Mie-ken (JP); TOYOTA JIDOSHA KABUSHIKI KAISHA, Aichi-ken (JP)

(21) Appl. No.: 19/347,963

(22) Filed: Oct. 2, 2025

(30) Foreign Application Priority Data
Oct. 8, 2024 (JP) 2024-176463

(51) Int. Cl. H01M 50/591; H01M 50/588; H01M 50/543

(52) U.S. Cl. CPC H01M 50/591; H01M 50/588; H01M 50/543

(57) ABSTRACT

A cover member includes a first cover segment that covers a first part of a power connection member extending in a lower direction and a second cover segment that covers a battery post and a second part of the power connection member extending in a front direction. The first cover segment includes a first coupling portion. The second cover segment is separate from the first cover segment and includes a second coupling portion configured to be coupled to the first coupling portion. The second cover segment includes a main body including the second coupling portion, a hinge formed integrally with the main body, and a lid formed integrally with the main body by way of the hinge. The lid is rotatable about the hinge between a closed position where the lid covers the battery post and an open position where the lid exposes the battery post.

### CROSS-REFERENCE TO RELATED APPLICATIONS

This application is based upon and claims the benefit of priority from Japanese Patent Application No. 2024-176463, filed on October 8, 2024, the entire contents of which are incorporated herein by reference.

### BACKGROUND

### 1. Field

The following description relates to a cover member.

### 2. Description of Related Art

JP2010-108785A discloses a cover member for protecting a battery post that projects from a battery and a power connection member attached to the battery post. This type of cover member includes a fuse unit protector arranged along a side surface of the battery, and a terminal protector formed integrally with the fuse unit protector by way of a hinge. The terminal protector covers the battery post and a battery terminal connected to the battery post. When replacing the battery with a new one during maintenance or the like, the terminal protection may be rotated upward about the hinge and opened. This exposes the battery post from the cover member and allows a jumper cable or the like to be connected to the battery post.

However, with the conventional cover member, when the terminal protector is rotated about the hinge and opened, the terminal protection is rotated over a wide range, and thus, the terminal protector may interfere with surrounding members.

It is an objective of the present disclosure to provide a cover member that can limit interference with the surrounding members of the terminal protector.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a cover member protecting a battery post of a battery and a power connection member attached to the battery post, the cover member includes a first cover segment that covers a first part of the power connection member extending in a first direction and a second cover segment that covers the battery post and a second part of the power connection member extending in a second direction intersecting the first direction. The first cover segment includes a first coupling portion. The second cover segment is separate from the first cover segment and includes a second coupling portion configured to be coupled to the first coupling portion. The second cover segment includes a main body including the second coupling portion, a hinge formed integrally with the main body, and a lid formed integrally with the main body by way of the hinge. The lid is rotatable about the hinge between a closed position where the lid covers the battery post and an open position where the lid exposes the battery post.

The cover member of the present disclosure provides an advantage of limiting interference with the surrounding components of the cover member.

Other features and aspects will be apparent from the following detailed description, the drawings, and the claims.

### BRIEF DESCRIPTION OF THE DRAWINGS

FIG. 1 is a perspective view of a cover member in accordance with one embodiment.

FIG. 2 is a perspective view of the cover member.

FIG. 3 is a perspective view of the cover member.

FIG. 4 is a perspective view of the cover member.

FIG. 5 is a plan view of the cover member.

FIG. 6 is a cross-sectional view of the cover member taken along line 6-6 in FIG. 5.

FIG. 7 is an exploded perspective view of the cover member.

FIG. 8 is a perspective view of a second cover segment of the cover member.

FIG. 9 is a cross-sectional view of the cover member taken along line 9-9 in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Embodiment of the present disclosure will now be described.

[1] A cover member protecting a battery post of a battery and a power connection member attached to the battery post, the cover member includes a first cover segment that covers a first part of the power connection member extending in a first direction and a second cover segment that covers the battery post and a second part of the power connection member extending in a second direction intersecting the first direction. The first cover segment includes a first coupling portion. The second cover segment is separate from the first cover segment and includes a second coupling portion configured to be coupled to the first coupling portion. The second cover segment includes a main body including the second coupling portion, a hinge formed integrally with the main body, and a lid formed integrally with the main body by way of the hinge. The lid is rotatable about the hinge between a closed position where the lid covers the battery post and an open position where the lid exposes the battery post.

With this structure, the cover member includes the first cover segment and the second cover segment, which is configured to be coupled to the first cover segment. The second cover segment includes the main body and the lid, which is formed integrally with the main body by way of the hinge. Further, the lid is rotated about the hinge between the closed position and the open position. Accordingly, the lid, which is part of the second cover segment, is rotated about the hinge. The entire second cover segment is not rotated about the hinge. Thus, the rotational range is narrower when rotating the lid about the portion where the first cover segment and the second cover segment are coupled than when rotating the entire second cover segment about the same portion. This limits interference between the lid and the surrounding members in a preferable manner.

[2] The cover member according to [1] in which the first cover segment is coupled to the first part in the second direction, and the second cover segment may be coupled to the first cover segment in the first direction and coupled to the second part in the first direction.

With this structure, the second cover segment is coupled in the first direction to the first cover segment and to the second part of the power connection member. Thus, movement of the second cover segment in the first direction allows the second cover segment to be coupled to the first cover segment, which is coupled to the first part of the power connection member, and to the second part in the same step. This increases the efficiency of coupling the second cover segment.

[3] The cover member according to [2] in which the first cover segment covers an end surface of the first part facing a second opposite direction that is opposite the second direction and exposes an end surface of the first part facing the second direction. The second cover segment covers an end surface of the second part facing a first opposite direction that is opposite the first direction, and exposes an end surface of the second part facing the first direction.

With this structure, the first cover segment covers the end surface of the first part of the power connection member facing the second opposite direction, and the second cover segment covers the end surface of the second part of the power connection member facing the first opposite direction.

[4] The cover member according to [2] or [3] in which the first coupling portion includes a first engaging portion. The second coupling portion includes a second engaging portion that is engageable with the first engaging portion. Engagement of the first engaging portion and the second engaging portion in the first direction maintains the first coupling portion and the second coupling portion in a state coupled to each other.

With this structure, engagement of the first engaging portion of the first coupling portion and the second engaging portion of the second coupling portion in the first direction restrict movement of the second coupling portion in the direction it is removed from the first coupling portion. This maintains the coupled state of the first coupling portion and the second coupling portion, that is, the coupling state of the first cover segment and the second cover segment, in a preferable manner.

[5] The cover member according to any one of [1] to [4] in which the hinge is connected to an end of the main body facing a third direction that intersects the first direction and the second direction.

With this structure, the lid is rotated between the open position and the closed position about the hinge, which is connected to the end of the main body in the third direction. Thus, when rotating the lid from the closed position to the open position, the lid is rotatable in the third direction, which intersects the first direction and the second direction.

[6] The cover member according to [5] in which the main body includes a first lock portion arranged in an end of the main body facing a third opposite direction that is opposite the third direction. The lid includes a second lock portion that is engageable with the first lock portion. Engagement of the first lock portion and the second lock portion maintains the lid at the closed position.

With this structure, engagement of the first lock portion of the main body with the second lock portion of the lid maintains the lid at the closed position. This restricts unintentional rotation of the lid to the open position. Accordingly, a situation in which the battery post is exposed unintentionally from the cover member will be avoided in a preferable manner.

[7] The cover member according to [6] in which the second cover segment extends from a part where the second cover segment is coupled to the first cover segment in the second direction. The second coupling portion is arranged at an end of the second cover segment facing a second opposite direction that is opposite the second direction. A shortest distance from the hinge to the second lock portion is shorter than a shortest distance from the second coupling portion to an end of the second cover segment facing the second direction.

With this structure, compared to when the entire second cover segment is rotated about the joining part of the first cover segment and the second cover segment, the rotational range of the lid is narrowed in a preferable manner.

[8] The cover member according to any one of [1] to [7] in which, when the lid is located at the open position, the lid overlaps a battery body of the battery in a plan view as taken from the first direction.

With this structure, enlargement of the entire structure of the battery body and the cover member may be avoided in a preferable manner compared to when the lid is arranged at the open position that does not overlap the battery body in a plan view as taken from the first direction.

### Detailed Description of Embodiment of Present Disclosure

Examples of a cover member of the present disclosure will now be described with reference to the drawings. The drawings may illustrate elements in an exaggerated or simplified manner for explanatory purposes. Further, elements have not necessarily been drawn to scale. In the specification, “parallel” or “orthogonal” may not be strictly parallel or orthogonal and may be substantially parallel or substantially orthogonal within a range that achieves the advantages of the present disclosure. Furthermore, in the specification, “facing” refers to a state in which two surfaces or two members face each other but is not limited to a state in which two surfaces or two members entirely face each other and includes a state in which they partially face each other. In the specification, “facing” is not limited to a state in which two members are spaced apart, and includes a state in which two members are in contact with each other. The drawings indicate a first axis X, a second axis Y orthogonal to the first axis X, and a third axis Z orthogonal to the first axis X and the second axis Y. Further, the drawings indicate a front direction X1, which is one direction extending along the first axis X, and a rear direction X2, which is the opposite direction extending along the first axis X. The drawings also indicate an upper direction Y1, which is one direction extending along the second axis Y, and a lower direction Y2, which is the opposite direction extending along the second axis Y. The drawings indicate a first width direction Z1, which is one direction extending in the third axis Z, and a second width direction Z2, which is the opposite direction extending along the third axis Z. The present invention is not limited to the illustrated embodiment and intended to be defined by the claims and their equivalents, and all variations within the scope of the claims and their equivalents.

### Overall Structure

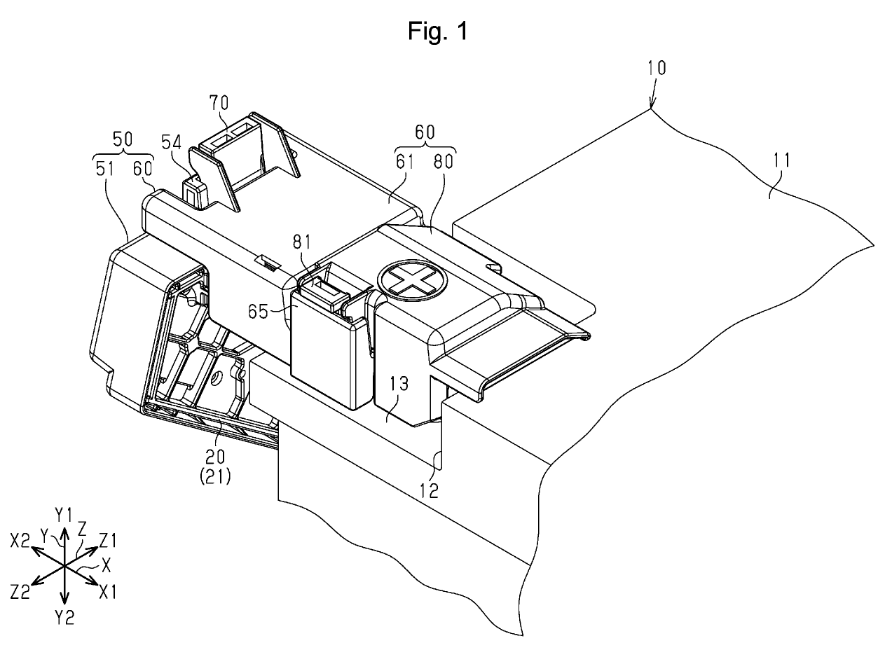

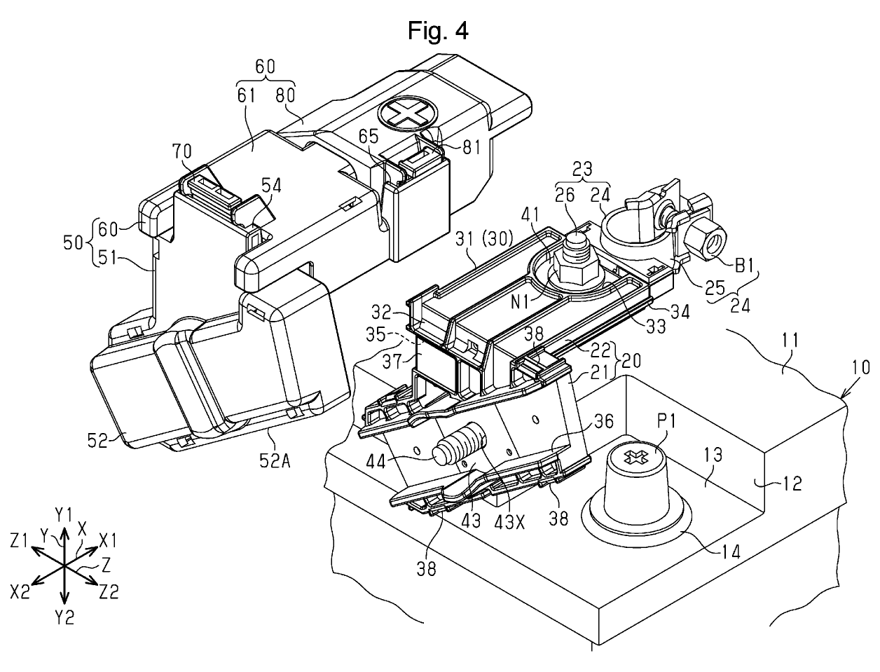

As shown in FIGS. 1 to 5, a battery 10 is mounted on a vehicle. As shown in FIG. 4, the battery 10 includes a battery body 11, a battery post P1, and a power connection member 20 attached to the battery post P1.

The battery body 11 is, for example, box-shaped. The battery body 11 has a recess 12 in a corner at the end surface facing the upper direction Y1. The recess 12 is formed in the battery body 11 by cutting out the end surface facing the upper direction Y1 so that the recess 12 is slightly lower than other surfaces. A bottom surface 13 of the recess 12 includes a seat 14. The bottom surface 13 is an end surface of the recess 12 facing the upper direction Y1. The seat 14 is disk-shaped and projects from the bottom surface 13 of the recess 12 in the upper direction Y1.

The battery post P1 projects from the seat 14 in the upper direction Y1. The battery post P1 has a form of a truncated cone that narrows in the upper direction Y1 from the seat 14. The battery post P1 is for the positive terminal. The power connection member 20 is connected to the battery post P1.

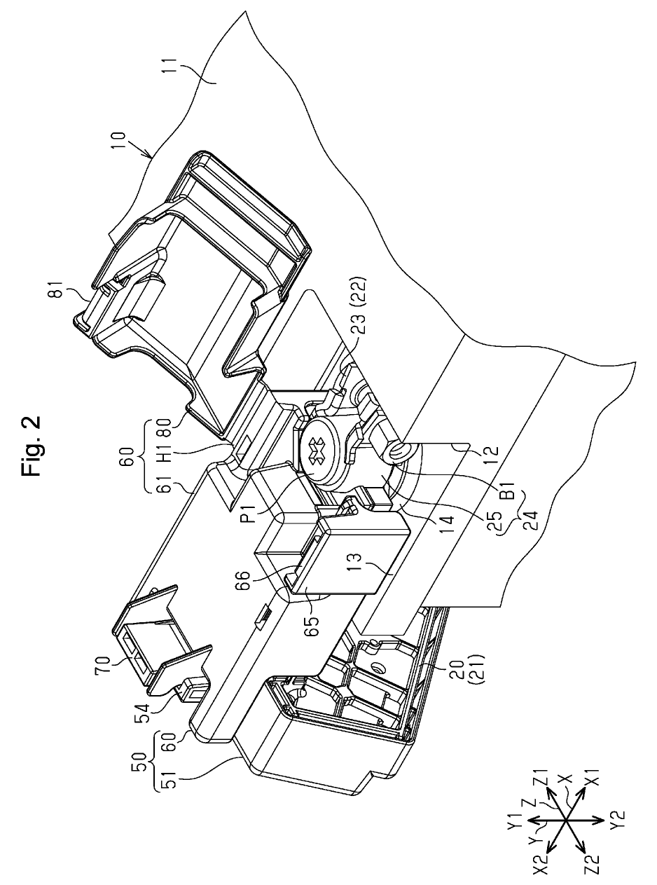

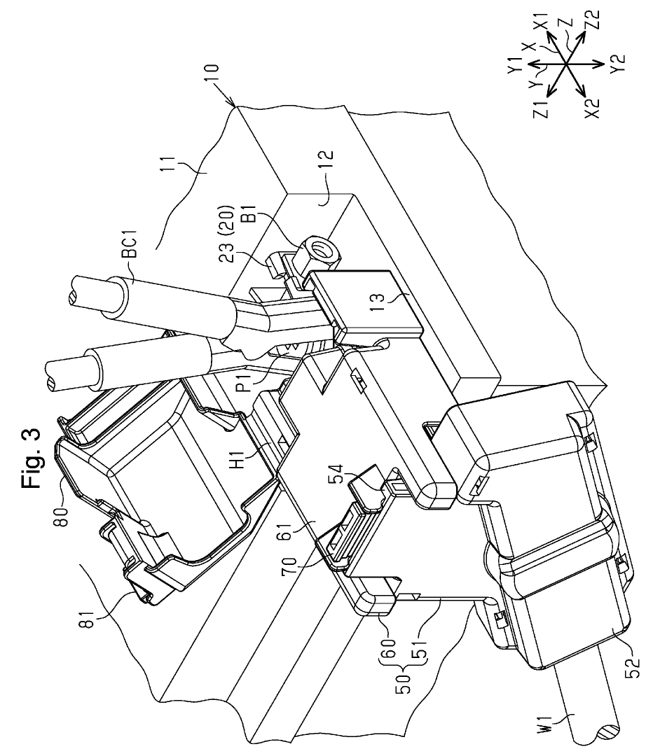

A cover member 50 is attached to the battery 10 to protect the battery post P1 and the power connection member 20. The cover member 50 is a battery terminal cover that covers the battery post P1 and the power connection member 20. As shown in FIGS. 2 and 3, the cover member 50 includes a portion that can be opened and closed to expose the battery post P1. As shown in FIG. 3, when the battery post P1 is exposed from the cover member 50, for example, a jumper cable BC1 can be connected to the battery post P1.

### Power Connection Member 20

As shown in Fig.4, the power connection member 20 includes a first part 21 extending in the lower direction Y2 and a second part 22 extending in the front direction X1. The first part 21 is arranged along a side surface of the battery body 11. More specifically, the first part 21 is arranged along an end surface of the battery body 11 facing the rear direction X2. The second part 22 extends, from an end of the first part 21 in the upper direction Y1, in the front direction X1. The second part 22 is arranged along an upper surface of the battery body 11 in the bottom surface 13 of the recess 12.

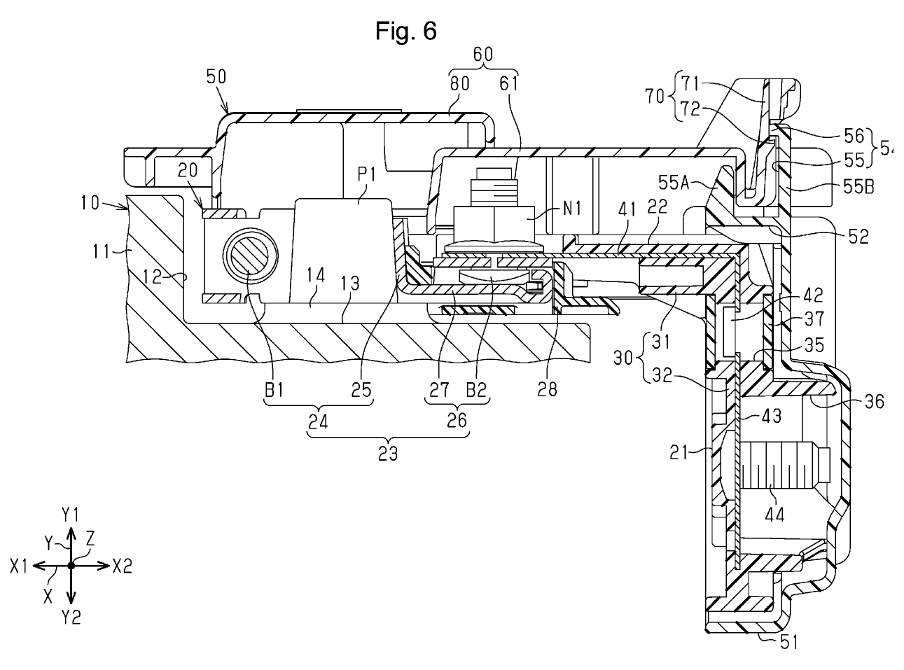

As shown in FIG. 6, the power connection member 20 includes a battery terminal 23, a holding member 28, and a housing 30. Further, the power connection member 20 includes a fuse element 41, a fuse 42, a fuse element 43, and a stud bolt 44 that are electrically connected to the battery terminal 23. The fuse element 41, the fuse 42, fuse element 43, and the stud bolt 44 are electrically connected to one another.

### Structure of Battery Terminal 23

The battery terminal 23 may be formed from a conductive material. The battery terminal 23 includes a first connecting portion 24 and a second connecting portion 26. The first connecting portion 24 is connected to the battery post P1.

As shown in FIG. 4, the first connecting portion 24 includes a fastening portion 25 that includes an insertion hole into which the battery post P1 can be inserted, and a bolt B1 fitted into an end of the first connecting portion 24. In the first connecting portion 24, when the bolt B1 is tightened, the diameter of the insertion hole in the fastening portion 25 is reduced. When the first connecting portion 24 is tightened by the bolt B1 in a state in which the battery post P1 is inserted in the insertion hole of the fastening portion 25, the first connecting portion 24 is mechanically and electrically connected to the battery post P1.

As shown in FIG. 6, the second connecting portion 26 includes a bolt B2 and a holding portion 27 that holds the bolt B2. The holding portion 27 is formed integrally with the fastening portion 25. In a state in which the bolt B2 is held in the holding portion 27, the bolt B2 is insertable into a bolt hole of the fuse element 41. The second connecting portion 26 is electrically connected to the fuse element 41 when a nut N1 is fastened to the bolt B2, which is inserted into the bolt hole of the fuse element 41. In this matter, the battery terminal 23 is electrically connected to the battery post P1 and is electrically connected to the fuse element 41. Thus, the battery terminal 23 electrically connects the battery post P1 and the fuse element 41 to each other.

### Structure of Holding Member 28

The holding member 28 is formed from, for example, synthetic resin. The holding member 28 holds the battery terminal 23. The holding member 28, for example, holds the second connecting portion 26 of the battery terminal 23.

### Structure of Housing 30

The housing 30 is formed from, for example, synthetic resin. The housing 30 holds the fuse elements 41 and 43, the fuse 42, and the stud bolt 44. The housing 30, for example, is formed integrally with the fuse elements 41 and 43, and the stud bolt 44 through insert molding. For example, the housing 30 is formed through insert molding using the fuse element 41 and 43, and the stud bolt 44 as inserts.

As shown in FIG. 4, the housing 30 is L-shaped in its entirety. The housing 30 includes a housing portion 31, arranged along the upper surface of the battery body 11, that is, the housing portion 31 extends parallel to the bottom surface 13 of the recess 12, and a housing portion 32, arranged along a side surface of the battery body 11, that is, the housing portion 32 extends parallel to the end surface of the battery body 11 in the rear direction X2. The housing 30 is a single component in which the housing portion 31 is formed continuously and integrally with the housing portion 32.

The housing portion 31 extends parallel to the bottom surface 13 of the recess 12. The housing portion 31 includes a predetermined width in the direction of the third axis Z and extends in the direction of the first axis X. The housing portion 31 extends in the front direction X1 from an end of the housing portion 32 in the upper direction Y1. The housing portion 31 holds the fuse element 41. The end of the housing portion 31 in the front direction X1 includes a receptacle 33, which extends through the housing portion 31 in the direction of the second axis Y. The receptacle 33 is formed by cutting out the end of the housing portion 31 facing the front direction X1. The receptacle 33 exposes a portion of an end of the fuse element 41 facing the front direction X1.

The housing portion 31 includes engaging portions 34. Each engaging portion 34 is arranged on a side surface of the housing portion 31. The engaging portions 34, for example, project outward from the end surfaces of the housing portion 31 in the direction of the third axis Z. The engaging portions 34 project in the direction of the third axis Z. The engaging portions 34 extend parallel to the first axis X.

As shown in FIG. 6, the end of the housing portion 31 in the front direction X1 faces the bottom surface 13 of the recess 12. The housing portion 31 is spaced apart from the bottom surface 13 of the recess 12. The end of the housing portion 31 in the rear direction X2 projects in the rear direction X2 from the end surface of the battery body 11 facing the rear direction X2.

As shown in FIG. 4, the housing portion 32 extends in the lower direction Y2 from the end of the housing portion 31 facing the rear direction X2. The housing portion 32 is, for example, bent orthogonally from the end of the housing portion 31 facing the rear direction X2. The housing portion 32 extends parallel to the end surface of the battery body 11 facing the rear direction X2. The housing portion 32 includes a fuse retainer 35 and an electric wire retainer 36. The fuse retainer 35 is located between the housing portion 31 and the electric wire retainer 36 in the direction of the second axis Y.

As shown in FIG. 6, the fuse retainer 35 extends through the housing portion 32 in the direction of the first axis X. The fuse 42 is accommodated in the fuse retainer 35. A fuse cover 37 attached to the fuse retainer 35 covers the fuse 42. The fuse cover 37 covers the fuse 42 so that the fuse 42 is accommodated in the fuse retainer 35 without being exposed to the outside.

As shown in FIG. 4, the electric wire retainer 36 is groove-shaped and has an opening facing the rear direction X2. In a plan view as taken from the front direction X1, the electric wire retainer 36 diagonally intersects the second axis Y and the third axis Z. The electric wire retainer 36 holds the fuse element 43 and the stud bolt 44. The electric wire retainer 36 exposes the portion of an end surface of the fuse element 43 facing the rear direction X2. The stud bolt 44, which projects from the end surface of the fuse element 43 in the rear direction X2, is exposed from the electric wire retainer 36 toward the rear direction X2. The electric wire retainer 36 accommodates an electric wire W1 as illustrated in FIG. 3. Although not shown in the drawings, the electric wire W1 has an end connected to a metal terminal with a bolt hole into which the stud bolt 44 is inserted. A nut is fastened to the stud bolt 44 to electrically connect the electric wire W1 to the fuse element 43. This allows the electric wire W1 to be electrically connected to the battery post P1 by the fuse element 43, the fuse 42 (refer to FIG. 6), the fuse element 41, and the battery terminal 23.

The housing portion 32 includes engaging portions 38. Each engaging portion 38 is arranged on a side surface of the housing portion 32. The engaging portions 38, for example, project outward from the side surfaces of the housing portion 32. The engaging portions 38 project in the direction of the second axis Y.

As shown in FIG. 6, the housing portion 32 faces the end surface of the battery body 11 located toward the rear direction X2. The housing portion 32 is spaced apart from the end surface of the battery body 11 located toward the rear direction X2.

### Structures of Fuse Elements 41 and 43, Fuse 42, and Stud Bolt 44

As shown in FIG. 6, most of the fuse element 41 is held by the housing 30 in a state embedded in the housing 30. The fuse element 41 is L-shaped in its entirety. The fuse element 41 extends in the directions of the first axis X and the second axis Y. The fuse element 41 is mechanically and electrically connected to the second connecting portion 26 of the battery terminal 23 by fastening the bolt B2 and the nut N1. When the fuse element 41 and the second connecting portion 26 are connected by fastening, the fuse element 41 and the bolt B2, the housing 30 and the battery terminal 23 are integrated.

An end of the fuse element 41 in the lower direction Y2 extends in the direction of the second axis Y and projects into the fuse retainer 35. The end of the fuse element 41 in the lower direction Y2 is electrically connected to the fuse 42.

The fuse element 43 is held in the housing 30 in a state partially embedded in the housing 30. The fuse element 43 extends in the direction of the second axis Y. The end of the fuse element 43 in the upper direction Y1 projects into the fuse retainer 35. The end of the fuse element 43 in the upper direction Y1 is electrically connected to the fuse 42. In this manner, the fuse 42 is electrically connected to the fuse element 41 and to the fuse element 43 inside the fuse retainer 35.

As shown in FIG. 4, the fuse element 43 includes a bolt hole 43X for insertion of a bolt portion of the stud bolt 44. The bolt hole 43X extends through the fuse element 43 in the direction of the first axis X. The bolt portion of the stud bolt 44 projects in the rear direction X2 from the end surface of the fuse element 43 located toward the rear direction X2 in a state in which the bolt portion of the stud bolt 44 extends through the bolt hole 43X of the fuse element 43. As shown in FIG. 6, a head portion of the stud bolt 44 is held in the housing 30 in a state embedded in the housing 30.

The first part 21 of the power connection member 20 is, for example, a fuse unit that includes the fuse 42. The second part 22 of the power connection member 20 is, for example, a terminal unit that includes the battery terminal 23.

### Structure of Cover Member 50

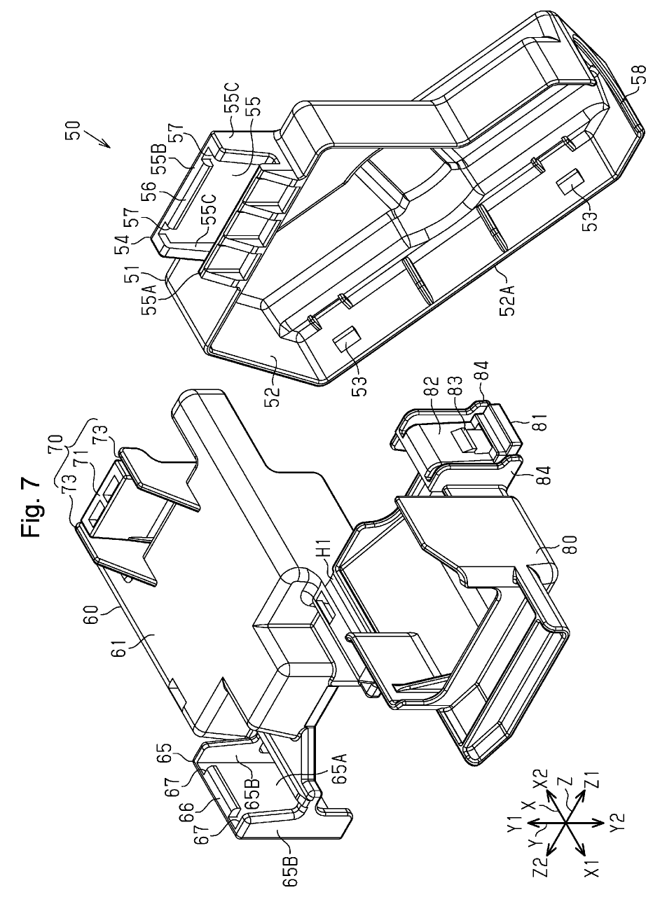

As shown in FIG. 7, the cover member 50 includes a first cover segment 51 and a second cover segment 60, which is separate from the first cover segment 51. The first cover segment 51 and the second cover segment 60 are configured to be coupled to each other. The second cover segment 60 may be attached to the first cover segment 51 in a removeable manner.

### Structure of First Cover Segment 51

As shown in FIG. 6, the first cover segment 51 covers the first part 21 of the power connection member 20, which extends in the lower direction Y2. The first cover segment 51 is coupled to the first part 21 in the front direction X1. The first cover segment 51 covers an end surface of the first part 21 in the rear direction X2 and exposes an end surface of the first part 21 in the front direction X1. The first cover segment 51 is, for example, coupled to the housing portion 32.

As shown in FIG. 7, the first cover segment 51 includes a first retainer 52 that is box-shaped. The first retainer 52 is open in the front direction X1. The first retainer 52 includes a peripheral wall 52A. The peripheral wall 52A is elastically deformable.

The inner surface of the first retainer 52 includes engaging portions 53. The engaging portions 53 project inward from the inner surface of the first retainer 52. More specifically, the engaging portions 53 project from the inner surface of the peripheral wall 52A in the direction of the second axis Y. The engaging portions 53 are engageable with the engaging portions 38 of the housing portion 32 illustrated in FIG. 4. As shown in FIG. 4, the first cover segment 51 is coupled to the housing portion 32 in the front direction X1. Elastic deformation of the peripheral wall 52A allows the engaging portions 53 (refer to FIG. 7) to be snap-fitted to the engaging portions 38. The engagement of the engaging portions 53 and the engaging portions 38 restricts movement of the first cover segment 51 in the direction it is removed from the housing portion 32. This keeps the first cover segment 51 coupled to the housing portion 32. In this state, as shown in FIG. 6, the inner space of the first retainer 52 accommodates the entire first part 21 of the power connection member 20. Further, the housing portion 32 is accommodated in the inner space of the first retainer 52 in a state in which an end surface of the housing portion 32 in the front direction X1 is exposed from the first retainer 52.

The first cover segment 51 includes a first coupling portion 54 coupled to the second cover segment 60. The first coupling portion 54 projects outward from the side surface of the first retainer 52. More specifically, the first coupling portion 54 projects in the upper direction Y1 from an end of the first accommodation 52 facing the upper direction Y1. The first coupling portion 54 includes a retainer 55, which accommodates a part of a second coupling portion 70 arranged in the second cover segment 60, and an engaging portion 56. As shown in FIG. 7, the first coupling portion 54, for example, includes guide grooves 57.

The retainer 55 includes peripheral walls 55A and 55B, which project in the upper direction Y1 from an end surface of the first retainer 52 facing the upper direction Y1, and projecting walls 55C. The peripheral wall 55A is arranged on the end surface of the first retainer 52 in the upper direction Y1 the end located toward the front direction X1. The peripheral wall 55B is arranged on the end surface of the first retainer 52 in the upper direction Y1 at the end located toward the rear direction X. The peripheral wall 55B extends in the upper direction Y1 from the end of the peripheral wall 55A located toward the upper direction Y1. The projecting walls 55C are arranged on the two ends of the peripheral wall 55B in the direction of the third axis Z. Each projecting wall 55C projects from the peripheral wall 55B in the front direction X1.

The engaging portions 56 project from the inner surface of the retainer 55 into the retainer 55. The engaging portion 56 projects in the front direction X1 from an end surface of the peripheral wall 55B facing the front direction X1. The engaging portion 56 is located at an end of the peripheral wall 55B in the upper direction Y1. The engaging portion 56 extends in the direction of the third axis Z. The engaging portion 56 is spaced apart from the projecting walls 55C in the direction of the third axis Z. The guide grooves 57 are formed by gaps between the engaging portion 56 and the projecting walls 55C.

The first cover segment 51 includes an opening 58 through which the inside and the outside of the first retainer 52 are connected. The opening 58 extends through the peripheral wall 52A of the first retainer 52. The opening 58 allows for insertion of the electric wire W1 illustrated in FIG. 3. In other words, the electric wire W1 extends out of the first cover segment 51 through the opening 58.

### Structure of Second Cover Segment

As shown in FIG. 6, the second cover segment 60 covers the second part 22 of the power connection member 20 that extends in the front direction X1. The second cover segment 60 is coupled to the second part 22 in the lower direction Y2. The second cover segment 60 covers an end surface of the second part 22 in the upper direction Y1 and exposes an end surface of the second part 22 in the lower direction Y2. The second cover segment 60 extends in the front direction X1 from where the first cover segment 51 is coupled. The second cover segment 60 is, for example, attached to the housing portion 31. The second cover segment 60 is coupled to the first cover segment 51 in the lower direction Y2.

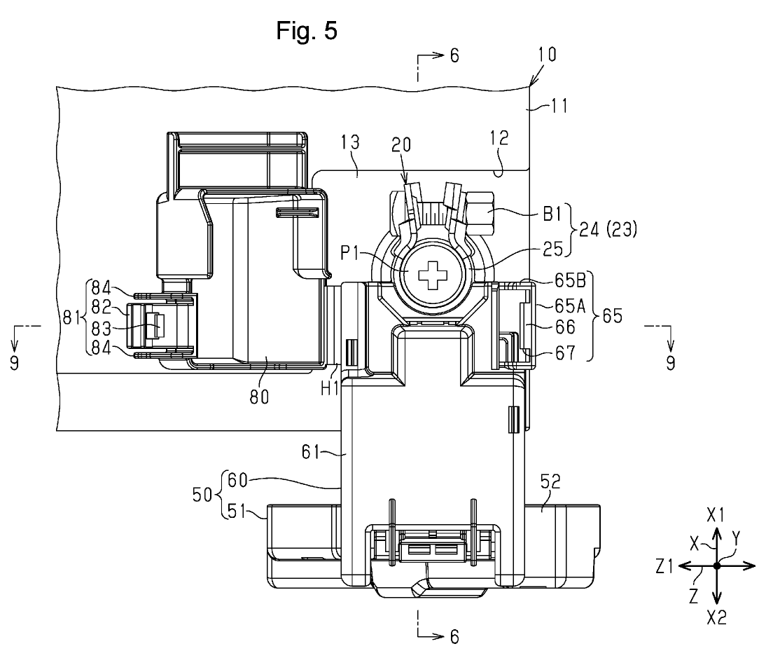

As shown in FIG. 7, the second cover segment 60 includes a main body 61 having a second coupling portion 70, a hinge H1 formed integrally with the main body 61, and a lid 80 formed integrally with the main body 61 by way of the hinge H1. The second cover segment 60 is a single component in which the main body 61, the second coupling portion 70, the hinge H1, and the lid 80 are formed continuously and integrally with one another. The lid 80 is rotatable about the hinge H1 relative to the main body 61. The lid 80 is rotatable about the hinge H1 between a closed position illustrated in FIGS. 1 and 6 and an open position illustrated in FIGS. 2 and 5. As shown in FIG. 6, when the lid 80 is in the closed position, the lid 80 covers the battery post P1. As shown in FIG. 2, when the lid 80 is in the open position, the lid 80 exposes the battery post P1 to the outside.

### Structure of Main Body 61

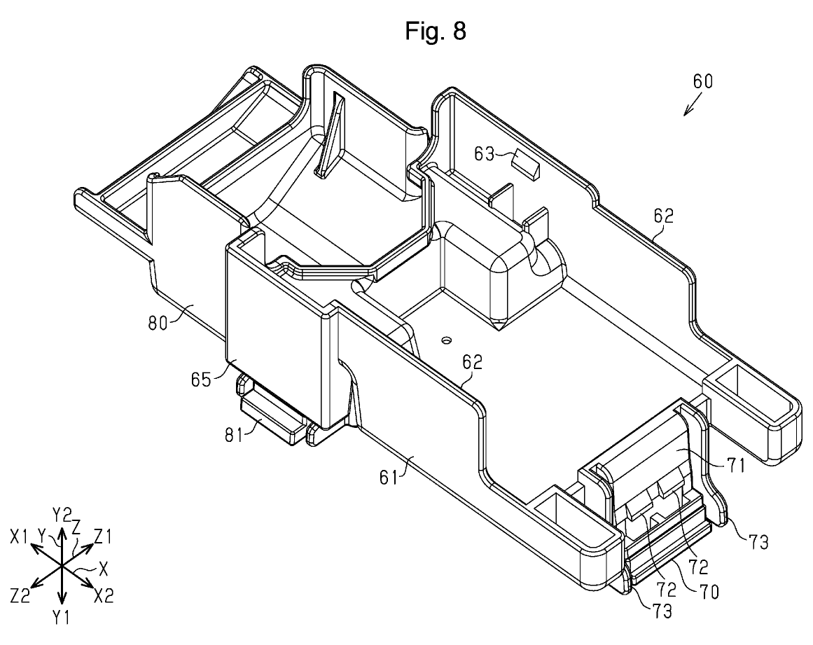

As shown in FIG. 8, the main body 61 is, for example, box-shaped in its entirety. The main body 61 is open toward the lower direction Y2. The main body 61 includes two side walls 62 arranged on each end of the main body 61 in the direction of the third axis Z and projecting in the lower direction Y2. The side walls 62 are elastically deformable. An inner surface of the main body 61 includes engaging portions 63. Each engaging portion 63 projects from the inner surface of the main body 61 into the main body 61. More specifically, each engaging portion 63 projects from the inner surface of one of the side walls 62 toward the inner surface of the other side wall 62. The engaging portions 63 project in the direction of the third axis Z. Each engaging portion 63 is arranged in the vicinity of the end of the side wall 62 in the lower direction Y2.

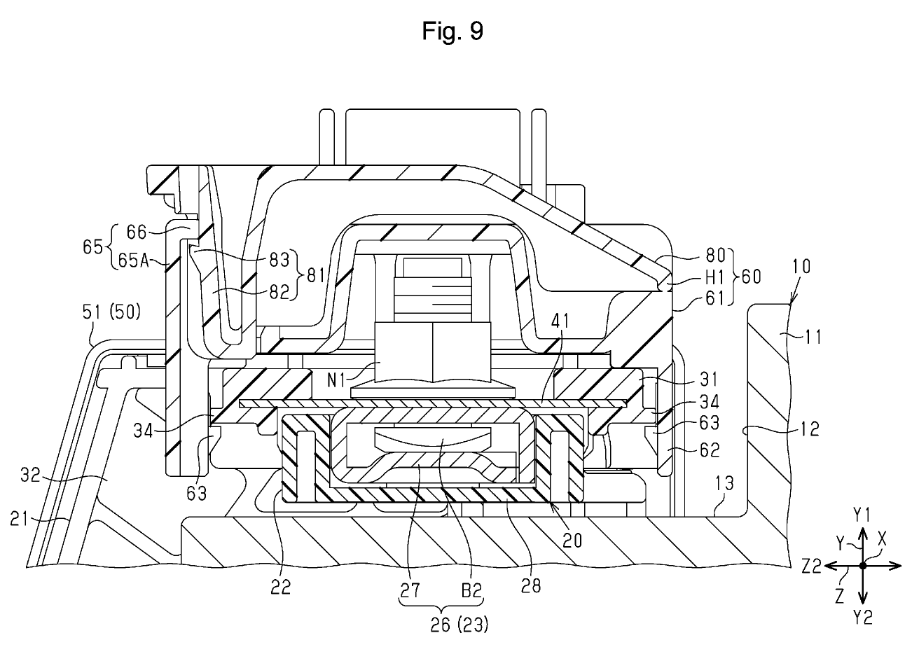

As shown in FIG. 9, the engaging portions 63 are engageable with the engaging portions 34 of the housing portion 31 in the direction of the second axis Y. The main body 61 is coupled to the housing portion 31 in the lower direction Y2. Elastic deformation of the side walls 62 allow the engaging portions 63 to be snap-fitted to the engaging portions 34. Engagement of the engaging portions 63 and the engaging portions 34 restrict movement of the main body 61 in the lower direction Y2. In other words, movement of the main body 61 in the direction it is removed from the housing portion 31 is restricted. This keeps the second cover segment 60 coupled to the housing portion 31. In this state, as shown in FIG. 6, the inner space of the main body 61 accommodates the entire housing portion 31 and the second connecting portion 26 of the battery terminal 23. The first connecting portion 24 of the battery terminal 23 and the battery post P1 are located outside of the main body 61.

As shown in FIG. 7, the main body 61 includes a first lock portion 65. The first lock portion 65 is arranged at an end of the main body 61 in the second width direction Z2. The first lock portion 65 is formed at an end of the main body 61 in the front direction X1. The first lock portion 65 includes a wall 65A that extends in the direction of the second axis Y, and two projecting walls 65B that are arranged at the two ends of the wall 65A in the direction of the first axis X and project from the wall 65A in the first width direction Z1. The wall 65A, the two projecting walls 65B, and a wall connected to the two projecting walls 65B form the first lock portion 65, which is frame-shaped in its entirety.

The first lock portion 65 includes an engaging portion 66 and guide grooves 67. The engaging portion 66 projects in the first width direction Z1 from an end surface of the wall 65A located toward the first width direction Z1. The engaging portion 66 is arranged at an end surface of the wall 65A in the upper direction Y1. The engaging portion 66 extends in the direction of the first axis X. The engaging portion 66 is arranged between the two projecting walls 65B. The engaging portion 66 is spaced apart from the projecting walls 65B in the direction of the first axis X. The guide grooves 67 are formed by the gaps between the engaging portion 66 and the projecting walls 65B.

As shown in FIG. 6, the main body 61 includes the second coupling portion 70 that is configured to be coupled to the first coupling portion 54 of the first cover segment 51. The second coupling portion 70 is arranged at the end of the second cover segment 60 in the rear direction X2. The second coupling portion 70 includes a coupling wall 71 that extends in the direction of the second axis Y. The coupling wall 71 is folded and extends in the upper direction Y1 from an end of the main body 61 in the lower direction Y2. The coupling wall 71 is elastically deformable.

As shown in FIG. 8, an end surface of the coupling wall 71 in the rear direction X2 includes one or more engaging portions 72. The present embodiment includes two engaging portions 72. The two engaging portions 72 are arranged next to each other in the direction of the third axis Z. The engaging portions 72 are located at the middle of the coupling wall 71 in the direction of the second axis Y. The engaging portions 72 project in the rear direction X2 from an end surface of the coupling wall 71 facing the rear direction X2.

As shown in FIG. 6, each engaging portion 72 is engageable with the engaging portion 56 of the first coupling portion 54 in the direction of the second axis Y. The main body 61 is coupled to the first cover segment 51 at the lower direction Y2. Elastic deformation of the coupling wall 71 allows the engaging portions 72 to be snap-fitted to the engaging portion 56. Engagement of the engaging portions 72 with the engaging portion 56 restricts movement of the second coupling portion 70 in the upper direction Y1, that is, movement of the second coupling portion 70 in the direction it is removed from the first coupling portion 54. This maintains the first coupling portion 54 and the second coupling portion 70 in a state coupled to each other and keeps the main body 61 of the second cover segment 60 coupled to the first cover segment 51. In this manner, the main body 61 of the second cover segment 60 is coupled to the housing portion 31 in the lower direction Y2 and coupled to the first cover segment 51 in the lower direction Y2.

As shown in FIG. 7, the second coupling portion 70 includes, for example, two guide walls 73. The two guide walls 73 are arranged on opposite sides of the coupling wall 71. The guide walls 73 are spaced apart from the coupling wall 71. The guide walls 73 are insertable into the guide grooves 57 of the first coupling portion 54 in the lower direction Y2. The guide walls 73 and the guide grooves 57 have the functionality of guiding insertion of the coupling wall 71 of the second coupling portion 70 into the retainer 55 of the first coupling portion 54.

### Structure of Hinge H1

As shown in FIG. 7, the hinge H1 is connected to an end of the main body 61 in the first width direction Z1. The hinge H1 is connected to an end of the main body 61 in the front direction X1. The hinge H1 connects the main body 61 and the lid 80.

### Structure of Lid 80

The lid 80 is formed integrally with the hinge H1. The lid 80 is box-shaped in its entirety. As shown in FIG. 6, in the closed position, the lid 80 opens toward the lower direction Y2. In the closed position, the lid 80 covers the battery post P1 and the first connecting portion 24, which are located outside the main body 61. As shown in FIG. 2, in the open position, the lid 80 overlaps with an end surface of the battery body 11 facing the upper direction Y1 in a plan view as taken from the lower direction Y2.

As shown in FIG. 7, the lid 80 includes a second lock portion 81 that is engageable with the first lock portion 65 of the main body 61. The second lock portion 81 is arranged at an end of the lid 80 in the first width direction Z1 in the open position. The second lock portion 81 includes a wall 82 extending in the second axis Y.

As shown in FIG. 9, in the closed position of the lid 80, the wall 82 is folded and extends in the upper direction Y1 from an end of the lid 80 located toward the lower direction Y2. The wall 82 is elastically deformable. An end surface of the wall 82 in the second width direction Z2 includes one or more engaging portions 83. The present embodiment includes one engaging portion 83. The engaging portion 83 is located in the middle of the wall 82 in the direction of the second axis Y. The engaging portion 83 projects in the second width direction Z2 from the end surface of the wall 82 located toward the second width direction Z2.

The engaging portion 83 is engageable with the engaging portion 66 of the first lock portion 65 in the direction of the second axis Y. Elastic deformation of the wall 82 allows the engaging portion 83 to be snap-fitted to the engaging portion 66. Engagement of the engaging portion 83 and the engaging portion 66 restrict movement of the lid 80 in the direction in which the lid 80 opens. This keeps the lid 80 at the closed position in a preferable manner.

As shown in FIG. 7, the second lock portion 81 includes, for example, two guide walls 84. The two guide walls 84 are arranged on opposite sides of the wall 82. Each guide wall 84 is spaced apart from the wall 82. The guide walls 84 are insertable into the guide grooves 67 of the first lock portion 65 along a rotational path of the lid 80. The guide walls 84 and the guide grooves 67 have the functionality of guiding insertion of the wall 82 of the second lock portion 81 into the frame shaped first lock portion 65.

The shortest distance from the hinge H1 to the second lock portion 81 is shorter than the shortest distance from the second coupling portion 70 to the end of the second cover segment 60 in the front direction X1.

An example of a coupling method of the cover member 50 will now be described with reference to FIG. 6. First, the first cover segment 51 of the cover member 50 is coupled to the housing portion 32 in the front direction X1. Then, the second cover segment 60 is coupled to the housing portion 31 and the first cover segment 51 in the lower direction Y2. This couples the first cover segment 51 and the second cover segment 60 and forms the cover member 50, which covers the battery post P1 and the power connection member 20.

### Operation of Present Embodiment

Operation of the present embodiment will now be described.

(1) The cover member 50 protects the battery post P1 of the battery 10 and the power connection member 20 attached to the battery post P1. The cover member 50 includes the first cover segment 51 that covers the first part 21 of the power connection member 20 extending in the first direction (the lower direction Y2). The cover member 50 includes the second cover segment 60 that covers the battery post P1 and the second part 22 of the power connection member 20 extending in the second direction (the front direction X1) intersecting the first direction. The first cover segment 51 includes the first coupling portion 54. The second cover segment 60 is separate from the first cover segment 51 and includes the second coupling portion 70 configured to be coupled to the first coupling portion 54. The second cover segment 60 includes the main body 61 including the second coupling portion 70, the hinge H1 formed integrally with the main body 61, and the lid 80 formed integrally with the main body 61 by way of the hinge H1. The lid 80 is rotatable about the hinge H1 between the closed position where the lid 80 covers the battery post P1 and the open position where the lid 80 exposes the battery post P1.

With this structure, the cover member 50 includes the first cover segment 51 and the second cover segment 60, which is configured to be coupled to the first cover segment 51. The second cover segment 60 includes the main body 61 and the lid 80, which is formed integrally with the main body 61 by way of the hinge H1. Further, the lid 80 is rotated about the hinge H1 between the closed position and the open position. Accordingly, the lid 80, which is part of the second cover segment 60, is rotated about the hinge H1. The entire second cover segment 60 is not rotated about the hinge H1. Thus, the rotational range is narrower when rotating the lid 80 about the portion where the first cover segment 51 and the second cover segment 60 are coupled than when rotating the entire second cover segment 60 about the same portion. This limits interference between the lid 80 and the surrounding members such as an ornamental cover.

(2) Further, the lid 80 is coupled to the main body 61 by the hinge H1 and is formed integrally with the main body 61 by way of the hinge H1. Thus, the lid 80 is connected to the main body 61 by the hinge H1 even if the lid 80 is rotated to the open position. This reduces the risk of the lid 80 becoming lost when opening and closing the lid 80.

(3) The first cover segment 51 is coupled to the first part 21 of the power connection member 20 in the front direction X1, and the second cover segment 60 is coupled to the first cover segment 51 in the lower direction Y2 and coupled to the second part 22 of the power connection member 20 in the lower direction Y2.

With this structure, the second cover segment 60 is coupled in the lower direction Y2 to the first cover segment 51 and to the second part 22 of the power connection member 20. Thus, movement of the second cover segment 60 in the lower direction Y2 allows the second cover segment 60 to be coupled to the first cover segment 51, which is coupled to the first part 21 of the power connection member 20, and to the second part 22 in the same step. For example, the second cover segment 60 may be coupled to the first cover segment 51 and the second part 22 during a coupling operation in a vehicle factory.

(4) The first cover segment 51 covers an end surface of the first part 21 of the power connection member 20 facing a second opposite direction (the rear direction X2) that is opposite the second direction (the front direction X1) and exposes an end surface of the first part 21 facing the second direction. The second cover segment 60 covers an end surface of the second part 22 facing a first opposite direction (the upper direction Y1) that is opposite the first direction (the lower direction Y2) and exposes an end surface of the second part 22 facing the first direction.

With this structure, the first cover segment 51 covers the end surface of the first part 21 of the power connection member 20 facing the rear direction X2, and the second cover segment 60 covers the end surface of the second part 22 of the power connection member 20 facing the upper direction Y1. Further, since the first cover segment 51 exposes the end surface of the first part 21 facing the front direction X1, the efficiency for coupling the first cover segment to the first part 21 is increased compared to when the first cover segment 51 covers both the end surface of the first part 21 facing the front direction X1 and the end surface of the first part 21 facing the rear direction X2. Furthermore, the second cover segment 60 exposes the end surface of the second part 22 in the lower direction Y2. This increases the efficiency for coupling the second cover segment 60 to the second part 22 compared to when the second cover segment 60 covers both the end surface of the second part 22 facing the lower direction Y2 and the end surface of the second part 22 facing the upper direction Y1.

(5) The first coupling portion 54 includes the engaging portion 56. The second coupling portion 70 includes the engaging portion 72 which is engageable with the engaging portion 56 in the direction of the second axis Y. With this structure, engagement of the engaging portion 56 and the engaging portion 72 in the direction of the second axis Y restricts movement of the second coupling portion 70 in the direction it is removed from the first coupling portion 54. This maintains the coupled state of the first coupling portion 54 and the second coupling portion 70, that is, the coupling state of the first cover segment 51 and the second cover segment 60, in a preferable manner.

(6) The hinge H1 is connected to an end of the main body 61 facing a third direction (the first width direction Z1) that intersects the first direction and the second direction. With this structure, the lid 80 is rotated about the hinge H1, which is connected to the end of the main body 61 in the third direction, between the open position and the closed position. Thus, when rotating the lid 80 from the closed position to the open position, the lid 80 is rotatable in the first width direction Z1, which intersects the lower direction Y2 and the front direction X1.

(7) The main body 61 includes a first lock portion 65 arranged in an end of the main body 61 facing a third opposite direction (the second width direction Z2) that is opposite the third direction. The lid 80 includes the second lock portion 81 that is engageable with the first lock portion 65. Engagement of the first lock portion 65 and the second lock portion 81 maintains the lid 80 at the closed position.

With this structure, engagement of the first lock portion 65 of the main body 61 with the second lock portion 81 of the lid 80 maintains the lid 80 at the closed position This restricts unintentional rotation of the lid 80 to the open position. Accordingly, a situation in which the battery post P1 is exposed unintentionally from the cover member 50 will be avoided in a preferable manner.

(8) The second cover segment 60 extends from a part where the second cover segment 60 is coupled to the first cover segment 51 in the front direction X1. The second coupling portion 70 is arranged at an end of the second cover segment 60 facing the rear direction X2. The shortest distance from the hinge H1 to the second lock portion 81 is shorter than the shortest distance from the second coupling portion 70 to an end of the second cover segment 60 facing the first direction X1.

With this structure compared to when the entire second cover segment 60 is rotated about the joining part of the first cover segment 51 and the second cover segment 60, the rotational range of the lid 80 is narrowed in a preferable manner. This limits interference between the lid 80 and surrounding members, such as an ornamental cover, in a preferable manner.

(9) When the lid 80 is located at the open position, as shown in FIGS. 2 and 3, the lid 80 overlaps the battery body 11 of the battery 10 in a plan view as taken from the lower direction Y2. With this structure, enlargement of the entire structure of the battery body 11 and the cover member 50 may be avoided in a preferable manner compared to when the lid 80 arranged at the open position that does not overlap the battery body 11 in a plan view.

### Modifications

The above embodiments may be modified as described below. The above embodiments and the following modifications may be combined as long as the combined modifications remain technically consistent with each other.

The structure of the first cover segment 51 of the above embodiment may be modified. For example, the opening 58 may be located at a different position.

The structure of the first coupling portion 54 may be modified. For example, the guide grooves 57 may be omitted from the first coupling portion 54.

The structure of the second cover segment 60 of the above embodiment may be modified. For example, the hinge H1 may be located at a different position For example, the hinge H1 may be connected to an end of the main body 61 facing the second width direction Z2. In another example, the hinge H1 may be connected to an end of the main body 61 facing the front direction X1.

The structure of the second coupling portion 70 may be modified. For example, the guide walls 73 may be omitted from the second coupling portion 70.

The structure of the first lock portion 65 may be modified. For example, the guide grooves 67 may be omitted from the first lock portion 65.

The structure of the second lock portion 81 may be modified. For example, the guide walls 84 may be omitted from the second lock portion 81.

The second axis Y of the illustrated non-limiting embodiments may be referred to as a height direction of the battery post P1. The cover member 50 of the illustrated non-limiting embodiments may be one example of a battery post cover or a battery post cover assembly.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A cover member protecting a battery post of a battery and a power connection member attached to the battery post, the cover member comprising:
a first cover segment that covers a first part of the power connection member extending in a first direction; and
a second cover segment that covers the battery post and a second part of the power connection member extending in a second direction intersecting the first direction, wherein
the first cover segment includes a first coupling portion,
the second cover segment is separate from the first cover segment and includes a second coupling portion configured to be coupled to the first coupling portion,
the second cover segment includes:
a main body including the second coupling portion;
a hinge formed integrally with the main body; and
a lid formed integrally with the main body by way of the hinge, and
the lid is rotatable about the hinge between a closed position where the lid covers the battery post and an open position where the lid exposes the battery post.

2. The cover member according to claim 1, wherein
the first cover segment is coupled to the first part in the second direction, and
the second cover segment is coupled to the first cover segment in the first direction and coupled to the second part in the first direction.

3. The cover member according to claim 2, wherein
the first cover segment covers an end surface of the first part facing a second opposite direction that is opposite the second direction and exposes an end surface of the first part facing the second direction, and
the second cover segment covers an end surface of the second part facing a first opposite direction that is opposite the first direction, and exposes an end surface of the second part facing the first direction.

4. The cover member according to claim 2, wherein
the first coupling portion includes a first engaging portion
the second coupling portion includes a second engaging portion that is engageable with the first engaging portion, and
engagement of the first engaging portion and the second engaging portion in the first direction maintains the first coupling portion and the second coupling portion in a state coupled to each other.

5. The cover member according to claim 1, wherein the hinge is connected to an end of the main body facing a third direction that intersects the first direction and the second direction.

6. The cover member according to claim 5, wherein
the main body includes a first lock portion arranged in an end of the main body facing a third opposite direction that is opposite the third direction,
the lid includes a second lock portion that is engageable with the first lock portion, and
engagement of the first lock portion and the second lock portion maintains the lid at the closed position.

7. The cover member according to claim 6, wherein
the second cover segment extends from a part where the second cover segment is coupled to the first cover segment in the second direction,
the second coupling portion is arranged at an end of the second cover segment facing a second opposite direction that is opposite the second direction, and
a shortest distance from the hinge to the second lock portion is shorter than a shortest distance from the second coupling portion to an end of the second cover segment facing the second direction.

8. The cover member according to claim 1 wherein, when the lid is located at the open position, the lid overlaps a battery body of the battery in a plan view as taken from the first direction.
